(19) United States
(12) Patent Application Publication
(10) Pub. No.: US 2010/0273951 A1
(43) Pub. Date: Oct. 28, 2010

(54) ANTI-BLOCKING AGENT MASTER BATCH AND POLYOLEFIN-BASED RESIN FILM USING THE SAME

(76) Inventors: Toshikatsu Shoko, Yokohama-shi (JP); Shozo Hayashi, Yokohama-shi (JP); Hideko Hayashi, Yokohama-shi (JP); Yasuo Togami, Yokohama-shi (JP); Akira Takagi, Yokohama-shi (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/681,478

(22) PCT Filed: Oct. 1, 2008
(86) PCT No.: PCT/JP2008/068256

§ 371 Date: May 25, 2010

(30) Foreign Application Priority Data
Oct. 4, 2007 (JP) 2007-261015

(51) Int. Cl. C08L 23/00; C08L 23/06; C08L 25/04

(52) U.S. Cl. 525/227; 525/55; 525/191; 525/241

(57) ABSTRACT

An anti-blocking agent master batch is provided, obtained by compounding 100 parts by mass of a polyolefin-based resin with 1 to 40 parts by mass of polymer fine particles, the polymer fine particles obtained by: causing two or more fluids including a liquid medium, a monomer or monomers, and a polymerization initiator to continuously and successively pass through a plurality of net bodies which are disposed at given intervals in a cylindrical passage and each have a surface crossing a direction of the passage to obtain an emulsion including liquid droplets containing the monomer or monomers and the polymerization initiator, the liquid droplets being dispersed in the liquid medium; and heating this emulsion to polymerize the monomer or monomers. Also provided is a manufacturing method thereof. The anti-blocking agent master batch can prevent the generation of die build-up during the manufacture of a master batch for a polyolefin-based resin film by compounding an anti-blocking agent into a polyolefin-based resin.

### TECHNICAL FIELD

The present invention relates to an anti-blocking agent master batch and a polyolefin-based resin film using the same. More particularly, the present invention relates to an anti-blocking agent master batch, wherein the master batch is capable of preventing the generation of die build-up during the manufacture of a master batch by using polymer fine particles as an anti-blocking agent, the master batch being suitably used for a polyolefin-based resin film. The present invention also relates to a polyolefin-based resin film using the same.

### BACKGROUND ART

A polyolefin-based resin film is widely used for various packaging materials because it is superior in transparency and mechanical property. However, when the polyolefin-based resin films overlap with each other, they are mutually adhered, namely, so-called blocking phenomenon may occur. In order to improve the slipping property and anti-blocking property of the polyolefin-based resin film, an anti-blocking agent is conventionally blended, thereby improving the anti-blocking property. Fine powdery inorganic materials had been widely used as an anti-blocking agent. Fine powdery polymer materials (polymer fine particles) have also been proposed as an anti-blocking agent.

In a method for industrially manufacturing a polyolefin-based resin film by compounding a polyolefin-based resin with an anti-blocking agent, the blended amount of the anti-blocking agent has been changed depending on the type of the used polyolefin-based resin, the thickness of the film, the intended use of the film, and the difference of the molding method. In order to effectively accommodate the change in the blended amount of the anti-blocking agent, it has been performed that a master batch pellet is previously prepared by compounding a polyolefin-based resin with an anti-blocking agent in a high concentration and a polyolefin-based resin pellet is blended with the prepared master batch pellet to finely adjust the blended amount of the anti-blocking agent (for example, Japanese Patent Application Laid-Open Nos. Hei. 8-225655 and Hei. 11-106520).

An anti-blocking agent master batch can be manufactured by mixing an anti-blocking agent and a polyolefin-based resin, melting and kneading the mixture with an extruder, extruding it through a die of the extruder in a strand shape, and cutting the strand into pellets. If required, various other additives such as an antioxidant, a lubricant, and an antistatic agent may be appropriately blended during the manufacture of the anti-blocking agent master batch. In this case, a resin agglomerate may grow around the outlet of the die of the extruder. Such a resin agglomerate may be referred to as “die build-up.” If such die build-up has a certain size, there are the problems in which the strand may be cut, the generated die build-up may be transferred with the strand to be mixed into pellets of the anti-blocking agent master batch, and the like. Accordingly, it is not preferred to generate die build-up. If a polyolefin-based resin is blended with the anti-blocking agent master batch having been mixed with die build-up to manufacture a film, film defects such as a fish eye and the like occur. Accordingly, when such die build-up is generated, cleaning must be done around the outlet of an extruder at predetermined intervals during the manufacture of the master batch. In doing so, the cut of a strand and suspend of operation are required, thereby significantly reducing the productivity. In addition to this, waste pieces from cutting resin are generated when the operation is resumed. This is noneconomic. Several methods have been proposed in which other compounds are added in order to suppress the generation of die build-up or improve the dispersibility of an anti-blocking agent (for example, see Japanese Patent Application Laid-Open Nos. Hei. 11-12403, 2001-114953, and 2007-91831).

### DISCLOSURE OF THE INVENTION

The methods described in the above-mentioned Japanese Patent Application Laid-Open Nos. Hei. 11-12403, 2001-114953, and 2007-91831, however, cannot suppress the generation of such die build-up sufficiently. Furthermore, if a new additive is added, the additive may affect the film performances in no small way. Accordingly, an object of the present invention is to provide an anti-blocking agent master batch being capable of preventing the generation of die build-up during the manufacture of a master batch by compounding a polyolefin-based resin with polymer fine particles as an anti-blocking agent.

The present invention relates to an anti-blocking agent master batch obtained by compounding 100 parts by mass of a polyolefin-based resin with 1 to 40 parts by mass of polymer fine particles, the polymer fine particles obtained by: causing two or more fluids including a liquid medium, a monomer or monomers, and a polymerization initiator to continuously and successively pass through a plurality of net bodies which are disposed at given intervals in a cylindrical passage and each have a surface crossing a direction of the passage to obtain an emulsion including liquid droplets containing the monomer or monomers and the polymerization initiator, the liquid droplets being dispersed in the liquid medium; and heating this emulsion to polymerize the monomer or monomers.

Furthermore, the present invention includes an embodiment in which the above polymer fine particles have an average particle diameter of 1 μm to 60 μm as determined by a Coulter Counter method and a CV value of 35% or less as determined by the following equation (1):

CV value=(Standard deviation of particle diameter distribution)/(Volume average particle diameter)×100 (1).

The present invention includes an embodiment in which the polymer fine particles are obtained by polymerizing an acrylic monomer or a styrenic monomer, or other polymerizable vinyl monomer or monomers.

The present invention includes an embodiment in which the polyolefin-based resin is a linear low-density polyethylene-based resin, and an embodiment in which the polyolefin-based resin is a polypropylene-based resin.

The present invention encompasses an embodiment in which the net bodies are disposed at intervals of 5 to 200 mm, an embodiment in which the number of the plurality of disposed net bodies are 5 to 100, and an embodiment in which a mesh size of the net bodies corresponds to that of a net having a mesh number of 35 to 4000 in accordance with an ASTM standard.

The present invention relates to a method for manufacturing an anti-blocking agent master batch, the method comprising compounding 100 parts by mass of a polyolefin-based resin with 1 to 40 parts by mass of polymer fine particles, the polymer fine particles obtained by: causing two or more fluids including a liquid medium, a monomer or monomers, and a polymerization initiator to continuously and successively pass through a plurality of net bodies which are disposed at given intervals in a cylindrical passage and each have a surface crossing a direction of the passage to obtain an emulsion including liquid droplets containing the monomer or monomers and the polymerization initiator, the liquid droplets being dispersed in the liquid medium; and heating this emulsion to polymerize the monomer or monomers.

Furthermore, the present invention includes an embodiment in which the above polymer fine particles have an average particle diameter of 1 μm to 60 μm as determined by a Coulter Counter method and a CV value of 35% or less as determined by the following equation (1):

CV value=(Standard deviation of particle diameter distribution)/(Volume average particle diameter)×100 (1).

The present invention includes an embodiment in which the polymer fine particles are obtained by polymerizing an acrylic monomer or a styrenic monomer, or other polymerizable vinyl monomer or monomers.

The present invention includes an embodiment in which the polyolefin-based resin is a linear low-density polyethylene-based resin, and an embodiment in which the polyolefin-based resin is a polypropylene-based resin.

The present invention encompasses an embodiment in which the net bodies are disposed at intervals of 5 to 200 mm, an embodiment in which the number of the plurality of disposed net bodies are 5 to 100, and an embodiment in which a mesh size of the net bodies corresponds to that of a net having a mesh number of 35 to 4000 in accordance with an ASTM standard.

Furthermore, the present invention relates to a polyolefin-based resin film prepared by compounding and molding a polyolefin-based resin, the above anti-blocking agent master batch of the present invention, and the anti-blocking agent master batch according to any of the above embodiments.

According to the present invention, in the manufacture of an anti-blocking agent master batch, the effect for preventing the generation of die build-up is superior. In addition, void generation in the master batch can also be suppressed. Furthermore, the anti-blocking agent master batch of the present invention is superior in hue. When a polyolefin-based resin is blended with this anti-blocking agent master batch and formed into a polyolefin-based resin film, the film processability during the film forming is superior and the obtained film has superior transparency and surface smoothness.

### BRIEF DESCRIPTION OF THE DRAWINGS

FIG. 1 is a perspective view illustrating one exemplary configuration of a continuous emulsification apparatus for use in the manufacture of polymer fine particles of the present invention.

FIG. 2 is a perspective view illustrating a spacer “c” for use in the manufacture of polymer fine particles of the present invention.

FIG. 3 is a cross section of an emulsification apparatus including 10 units as one prototype example in the manufacture of polymer fine particles of the present invention.

FIG. 4 is a diagram illustrating a flow chart including emulsification raw material tanks, plunger pumps, an emulsification apparatus F, and a product tank for use in the manufacture of polymer fine particles of the present invention.

FIG. 5 is a graph showing the relationship between the added amount of polymer fine particles and the strength of film blocking effect.

In the drawings, reference sign “a” denotes a casing, “b” a gauze, “c” a spacer, and “2a” a stopper.

### BEST MODE FOR CARRYING OUT THE INVENTION

### Polyolefin-Based Resin

The polyolefin-based resin for use in the present invention is a homopolymer or a copolymer of an olefin-based monomer, or a mixture thereof. The “olefin-based monomer” shall mean ethylene and an α-olefin. Examples of the α-olefin include propylene, butene-1, hexene-1,4-methylpentene-1, and octene-1. The olefin-based monomer can also include copolymers of olefin and vinyl ester, α,β-unsaturated carboxylic acid, and their derivatives.

A polyolefin-based resin suitable for manufacturing a film is particularly preferable. Publicly known polyethylene-based resins, polypropylene-based resin, and the like resins can be used, for example. Examples of the polyethylene-based resin include ethylene homopolymers, copolymers of ethylene and another α-olefin, such as a high density polyethylene, a low density polyethylene, a super low density polyethylene, and the like, copolymers of ethylene and vinyl ester, α,β-unsaturated carboxylic acid, or derivatives thereof, and a linear polyethylene resin (LLDPE) that is a copolymer of ethylene and α-olefin. Examples of the polypropylene-based resin include crystalline propylene homopolymers, and copolymers of propylene and ethylene or another α-olefin.

### (Polymer Fine Particle)

The polymer fine particle for use in the present invention can be obtained by emulsifying and polymerizing a monomer or monomers. The emulsification apparatus used in the emulsifying step has a plurality of net bodies disposed at given intervals in a cylindrical passage. The polymer fine particles of the present invention can be obtained by feeding two or more fluids including a liquid medium, a monomer or monomers, a polymerization initiator, and a dispersing agent (emulsifying agent) in the cylindrical passage; causing the fluids to successively and continuously pass through the plurality of net bodies to obtain an emulsion including liquid droplets containing the monomer or monomers and the polymerization initiator, the liquid droplets being dispersed in the liquid medium; heating this emulsion to polymerize the monomer or monomers; and separating and removing the liquid medium.

Suspension polymerization itself can be performed based on known methods using a liquid medium, a monomer or monomers, initiator and a dispersing agent (emulsifying agent). Preferred embodiments in the present invention are as follows.

Examples of the monomer include acrylic monomers and styrenic monomers. Examples of the acrylic monomer include acrylic acid and acrylate derivatives such as methyl acrylate, ethyl acrylate, and butyl acrylate; and methacrylic acid and methacrylate derivatives such as methyl methacrylate, ethyl methacrylate and butyl methacrylate. Examples of the styrenic monomer include styrene and styrene derivatives such as methyl styrene, ethyl styrene, propyl styrene, and butyl styrene. Examples of other usable monomers include polymerizable vinyl monomers such as vinyl acetate, vinyl chloride, vinylidene chloride, acrylonitrile, and methacrylonitrile.

Preferred liquid medium is water. A radical initiator for use in suspension polymerization can be preferably used as the initiator. Specifically, examples of the initiator include diacyl peroxide, peroxy ester, and dialkyl peroxide.

Examples of the dispersing agent (emulsifying agent) preferably include various dispersing agents (emulsifying agents) such as anionic surfactants, cationic surfactants, nonionic surfactants, and amphoteric surfactants. In an exemplary case where a hydrophobic liquid is emulsified in water, PVA (polyvinyl alcohol) is used as the dispersing agent (emulsifying agent) and a 1 mass % aqueous solution thereof can be used as the liquid medium.

It is preferred that the polymer fine particles be cross-linked to a certain extent sufficient for maintaining its shape during the respective steps such as heating, kneading, molding, stretching, and the like when the film is manufactured. Any radical polymerizable monomer can be used as a cross-linking agent as long as it includes two or more vinyl groups. Examples of the cross-linking agent include divinyl benzene, ethylene glycol diacrylate, trimethylolpropane triacrylate, trimethylolpropane trimethacrylate, pentaerythritol tetraacrylate, and pentaerythritol tetramethacrylate.

The raw materials for emulsification to be supplied into the cylindrical passage of an emulsification apparatus generally include a liquid comprising a liquid medium and a liquid containing a monomer or monomers, a polymerization initiator, a cross-linking agent, a solvent, and the like. These liquids, however, are not necessarily mixed prior to the supply into the emulsification apparatus. These liquids are fed to the cylindrical passage by appropriate feed pumps (liquid feed pump), respectively. For example, when an O-W type emulsion is prepared, an oil and water can be separately fed into a flow passage by respective feed pumps. Of course, they may be mixed in advance. There is no specific limit on mixing means when these liquids are introduced into a cylindrical passage of an emulsification apparatus. It is not necessary to employ an apparatus for mixing the liquids such as a stirrer. Generally, these liquids are preferably mixed by means of an in-line blending technique for introduction.

It should be noted that when the raw materials for emulsification reach the net bodies while completely separately flowing, namely, when they are absolutely not mixed with each other, it is difficult to carry out emulsification by fluid division through the net bodies, which is an emulsification mechanism of the present invention. Accordingly, it is preferable that the raw materials for emulsification in a certain pre-mixed state be allowed to reach the net bodies. The degree of mixing obtained by the in-line blending technique may be sufficient for the purpose.

Any of the above-mentioned raw materials for emulsification can be mixed in advance with the emulsifying agent and the dispersing agent. If necessary, these may be separately fed directly into the emulsification apparatus.

The flow rate of the fluid flowing through the flow passage of the emulsification apparatus is not necessarily as high as a flow rate that causes collision and breakage of liquid droplets because the fluid flow is divided by the net bodies that are used as the emulsification mechanism (described later) in the present invention. However, when the flow rate is too low, small droplets formed by dividing the liquid flow are more likely to coalesce again. Accordingly, an appropriate flow rate is maintained. Preferably, the linear velocity is about 0.1 to 50 cm/sec. As described below, specifically in the present invention, the net bodies, for example, such as gauzes, having large opening areas are used. In this case, although a plurality of net bodies are used, they are disposed at predetermined intervals. Accordingly, the pressure loss in the fluid system can be reduced. Therefore, the linear velocity of the fluid can be made relatively large. As a result, this can increase the material throughput per unit time.

The net bodies are disposed in the flow passage at a plurality of locations at predetermined intervals. Then, the fed raw materials for emulsification can successively pass through the plurality of net bodies, during which emulsification proceeds and is completed. The net bodies each have a surface that intersects the direction of the flow passage. There is no specific limit on the degree of intersection as long as the flow is divided by the emulsification mechanism of the present invention (described later). Preferably, the surfaces of the net bodies are substantially perpendicular to the direction of the flow passage.

The present inventors have interpreted the action and effect of the emulsification mechanism and the net bodies in the present invention as follows. When the fluid successively passes through the net bodies, it is divided into small droplets by a large number of fine holes of the net bodies, and only the droplets having large particle diameters among the small droplets are further divided by the succeeding net bodies. This may result in uniformity of the particle diameter of the liquid droplets of the dispersed phase.

When the distance from one net body to a succeeding net body is long, small droplets generated by the first net body can coalesce before they reach the succeeding net body. Therefore, it is important that the distance therebetween is not too long and is set appropriately.

The intervals between the adjacent net bodies are 5 mm to 200 mm, though depending on the flow rate of the fluid, the viscosity of the fluid, and the like in the flow passage. The intervals are more preferably 10 mm to 100 mm. Herein, longer intervals are used for high flow rates. When the viscosity of the fluid is high, in contrast, shorter intervals are preferably used.

The number of the net bodies is preferably 5 to 100. When the number is 5 or less, the uniformity of the particle diameter of the liquid droplets of the dispersed phase in the obtained emulsion deteriorates. When the number exceeds 100, the pressure during the emulsification operation becomes significantly high, which is not preferred. The number of the net bodies is more preferably 10 to 80, and particularly preferably 30 to 50. When the raw materials for emulsification are caused to pass the emulsification apparatus in a plurality of numbers for recycling, the number of the net bodies disposed in the apparatus can be economically reduced.

If gauzes are used as the net bodies, the degree of opening, density, and the like of the fine holes can be appropriately selected according to the mesh size. This is achieved because gauzes have certain mechanical strength and different types of gauzes having various mesh sizes are available. Therefore, any net bodies made of any material can be appropriately used as long as they are equivalent to gauzes.

The mesh number of the net bodies is preferably 35 mesh to 4000 mesh in accordance with an ASTM standard to be described later and more preferably 150 mesh to 3000 mesh. If necessary, the net bodies used may have a multilayer stacked structure for the purpose of reinforcement and the like. Net bodies each having an excessively large thickness are not preferred. Therefore, the thickness of the gauzes is generally several mm or less, even when multilayer stacks are employed. It is preferable that the gauzes be supported by appropriate spacers (described layer) or the like to reinforce the mechanical strength of the gauzes. Generally, the thickness for gauzes used as filters in various liquid and gas filtration applications is enough.

There is no specific limit on the temperature in the flow passage during the emulsification operation, but it is possible to appropriately cool or heat the space in the flow passage in order to adjust the viscosity of materials. The temperature in the flow passage is preferably 10 to 40° C.

The pressure in the flow passage can also be changed Appropriately in order to adjust the flow rate of the fluid. Namely, it is sufficient that the pressure can be adjusted so that the preferable flow rate described above is maintained, and a particularly high pressure is not required. A high-pressure fluid is not preferred because a sufficient time to stabilize the fluid between the plurality of net bodies is not obtained. In such a case, the frequency of collision and pulverization increases, and the fluid is divided excessively. This causes an increase in instability. The pressure in the flow passage is preferably 0.01 to 1.0 MPa.

Hereinafter, an apparatus for manufacturing polymer fine particles of the present invention will be described in detail with reference to the accompanying drawings.

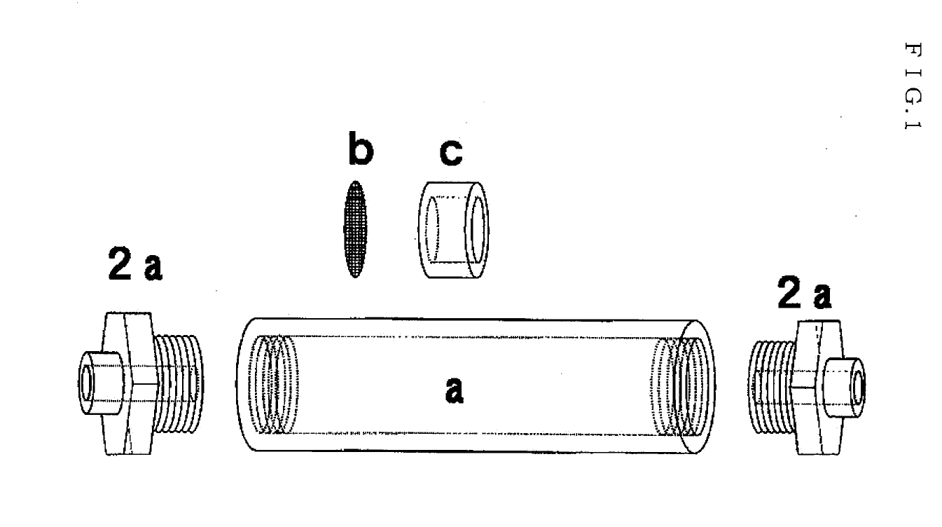

An emulsification apparatus of FIG. 1 is composed of a cylindrical casing “a”, units each composed of a pair of a gauze “b” and a spacer “c” inside the casing and stoppers 2a for securing the units.

The spacers “c” hold the plurality of gauzes “b” at predetermined intervals. The length of the casing “a” is determined by the length of the unit composed of the gauze “b” and the spacer “c” and the number of the units secured inside the casing “a.” The pressure resistance performance of the casing “a” is determined by the amount (pressure) of the raw materials for emulsification fed to and flowing through the secured units and is appropriately designed. Although there is no specific limit on the cross-sectional shape of the casing into which the units are inserted, a cylindrical shape as shown in FIG. 1 is preferred from the viewpoint of workability and pressure resistance or to prevent the liquid passing through the inside of the casing from remaining therein. There is no specific limit on the materials for the casing “a,” the gauzes “b,” the spacers “c,” and the stoppers 2a as long as the materials are resistant to corrosion by the raw materials for emulsification that pass inside thereof and have strengths enough to resist the pressure generated during the emulsification operation.

In FIG. 1, the shape of the gauzes “b” is configured such that the shape and the size thereof are substantially the same as those of the interior cross-section of the cylindrical casing “a.” This is because the gauzes “b” can be secured inside the cylindrical casing “a” without distortion, and the raw materials for emulsification are caused to pass through the flow passage formed by the plurality of units reliably. When a gauze “b” and a spacer “c” are stacked to form a unit, their contact surfaces must be brought into tight contact with each other. This is because the raw materials for emulsification can pass only through the flow passage formed by the gauzes “b” and the spacers “c,” so that the raw materials for emulsification are reliably emulsified.

The gauzes “b” preferably have mesh numbers in the range of 35 mesh to 4000 mesh in accordance with the ASTM standard. The mesh number may be appropriately selected according to the raw materials for emulsification used and the target diameter of the liquid droplets of the dispersed phase in the emulsion. When the mesh number is less than 35 mesh, the emulsification action significantly deteriorates, which is not preferable. When the mesh number exceeds 4000 mesh, the operating pressure during the emulsification operation becomes excessively high. This is not preferable because emulsification cannot be achieved. The mesh number of the gauzes is more preferably 150 mesh to 3000 mesh. There is no specific limit on the shape of the gauzes, and any of plain-woven, twilled, plain dutch woven, twilled dutch woven, and quadruple twilled woven gauzes may be preferably used.

For the purpose of surface protection, maintenance of strength, and dispersion control, the gauzes may have a multilayer structure in which a plurality of layers are stacked. Hereinafter, a gauze included in the multilayer structure and used for emulsification is referred to as a main gauze. There is no specific limit on the shape of the material stacked on the main gauze as long as the material can achieve the surface protection, maintenance of strength, and dispersion control. Preferably, punched metal, a gauze, and the like are preferred. When a gauze (hereinafter referred to as a “sub-gauze”) is used for the above purpose, the mesh number (ASTM standard) of the sub-gauze must be less than the mesh number of the main gauze (the meshes of the sub-gauze must be greater than those of the main gauze). In the emulsification apparatus for use in the manufacture of the polymer fine particle of the present invention, the properties of the obtained emulsion are determined by the gauze having the largest mesh number (main gauze) among the gauzes disposed in the flow passage of the emulsification apparatus. Therefore, it is not preferable to use a sub-gauze having a mesh number greater than that of a main gauze. When a main gauze including a plurality of stacked layers is used, it is preferable to secure each layer by sintering or the like for the purpose of preventing the deformation or the like of the main gauze in the flow passage of the emulsification apparatus.

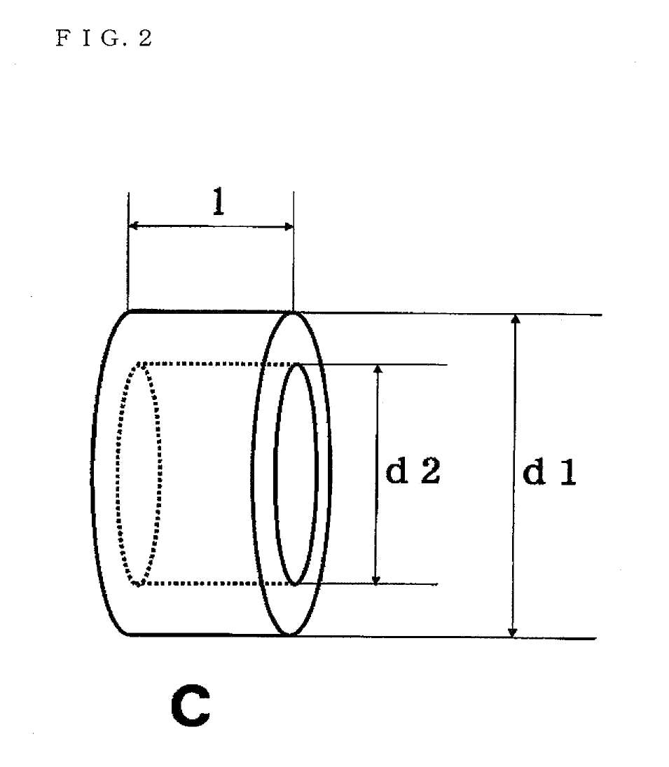

In the emulsification apparatus for use in the manufacture of the polymer fine particles of the present invention, as described above, the distances between the net bodies are related to emulsification and the stabilization of the liquid droplets of the dispersed phase in the emulsion. Therefore, the net bodies must be secured in predetermined positions in the cylindrical flow passage at predetermined intervals. For example, spacers are used to achieve this purpose. FIG. 2 shows the spacer “c.”

Although there is no specific limit on the length L of the spacer, the length L corresponds to the preferred distance between the net bodies described above and is preferably 5 mm to 200 mm. The length L is more preferably 7 mm to 100 mm and particularly preferably 10 mm to 100 mm. When the length of the spacer is less than 5 mm, the particle diameter of the liquid droplets of the dispersed phase in the emulsion becomes non-uniform, which is not preferred. When the length of the spacer is greater than 200 mm, the length of the main body of the emulsification apparatus becomes too long. In this case, coalescence (aggregation) of the liquid droplets of the dispersed phase in the emulsion occurs undesirably in the spacer portions (the spaces between the net bodies), or a dead space is undesirably formed. Preferably, the outer diameter d1 of the spacer is close to the inner diameter of the casing, provided that the spacers can be inserted into the cylindrical casing “a.” This allows the gauzes to be completely secured inside the flow passage and allows the raw materials for emulsification to be reliably guided to the flow passage formed by the spacers and the gauzes. Preferably, the inner diameter d2 of the spacer is set, with respect to the outer diameter d1, within the range such that (d1−d2)/d1=0.01 to 0.5 is satisfied. More preferably, the range is 0.1 to 0.3. When this value is less than 0.01, the gauzes are not secured appropriately, which is not preferable. When the value is greater than 0.5, the flow passage is significantly reduced in size. This configuration undesirably lowers the emulsification efficiency.

When the emulsification apparatus for use in the manufacture of the polymer fine particles of the present invention is used, a plurality of units each composed of a pair of the gauze “b” and the spacer “c” are inserted into the cylindrical casing “a.” Although the number of the inserted units is not specifically limited as long as the plurality of units are inserted, it is preferably 5 to 100. When the number of the units is less than 5, the uniformity of the particle diameter of the liquid droplets of the dispersed phase in the emulsion is unpreferably poor. When the number of the units exceeds 100, the pressure during the emulsification operation unpreferably becomes significantly high. The number of the units is more preferably 10 to 80, and particularly preferably 30 to 50. In order to suppress the pressure increase, an apparatus having the units the number of which is less than 50 can be used to cause the emulsion to pass the apparatus in a plurality of numbers.

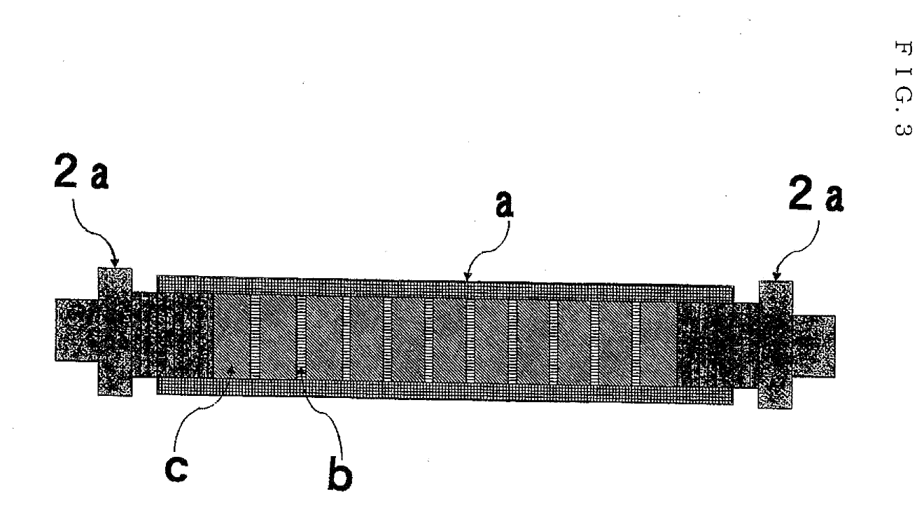

FIG. 3 shows an example of the emulsification apparatus composed of ten units. In the example shown in FIG. 3, one additional spacer, in addition to the ten units of the gauzes and spacers, is inserted into the casing, so that the surface of the gauze is prevented from being damaged by the contact between the gauze and a stopper. In the present example, each unit is secured inside the casing by screwing the stoppers into the casing. However, there is no specific limit on the manner of securing as long as the securing means can provide the same function. For example, clamps or flanges may be used.

In the emulsification apparatus for use in the manufacture of the polymer fine particles of the present invention, the cylindrical casing may be heated or cooled from the outside, if necessary. In this manner, the temperature during emulsification can be controlled. The temperature of the casing can be controlled, for example, by attaching a band- or ribbon-like heater to the exterior of the casing, using an open- or hermetically-closed type tubular electric furnace, attaching a heating/cooling jacket to the exterior of the casing, or the like.

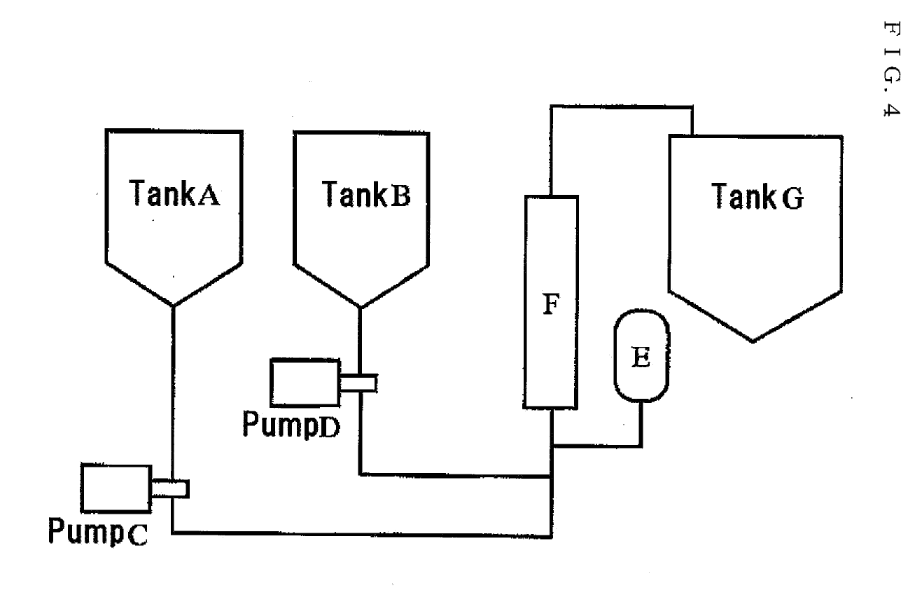

Next, the procedure for introducing the raw materials into the emulsification apparatus for use in the manufacture of the polymer fine particles of the present invention and performing emulsification will be specifically described with reference to FIG. 4. In FIG. 4, tanks A and B are used as tanks for the raw materials for emulsification, respectively.

For example, a hydrophobic liquid including a monomer or monomers, a polymerization initiator, a cross-linking agent, a solvent, and the like is stored in the tank A, and water is stored in the tank B.

A dispersing agent (emulsifying agent) is charged into any one of the raw material tanks. In this instance, the dispersing agent is stored as an aqueous solution in the tank B.

There is no specific limit on the amount and type of the dispersing agent (emulsifying agent) used. Any dispersing agent (emulsifying agent) such as anionic, cationic, nonionic, and amphoteric surfactants and the like may be used. For example, to emulsify a hydrophobic liquid in water, PVA (polyvinyl alcohol) may be used as the dispersing agent (emulsifying agent), and an aqueous solution of about 1 mass % may be used as the liquid medium.

A stirrer, a heater, and the like may be appropriately attached to the tanks A and B for the purpose of preparing the raw materials for emulsification. Pumps C and D are plunger pumps that can regulate flow rates and are used to introduce the raw materials for emulsification into the emulsification apparatus at any given ratio. There is no specific limit on the amounts of fed liquids. Generally, the amounts are about 6 to 3,000 ml/cm²/min.

The raw materials for emulsification from the respective pumps are fed to an inlet-side line of the emulsification apparatus F and are in-line blended, so that the mixture is introduced into the emulsification apparatus F.

An accumulator E may be provided on the pump side of the inlet for the raw materials for emulsification of the emulsification apparatus F in order to prevent pulsation of the fluid. Any pumps capable of stably feeding the raw materials at target flow rates may be used to introduce the raw materials into the emulsification apparatus F. There is no specific limit on the types of the pumps. For example, the plunger pump described above may be used.

After emulsification in the emulsification apparatus F, the product is received by a tank G. The tank G is used as a reception tank for the emulsion as the product.

A stirrer, a heater, and the like may be attached to the product tank G for the purpose of performing a polymerization.

By preparing an aqueous emulsion of a monomer such as methyl methacrylate (MMA) monomer or styrenic monomer containing an initiator, and heating the emulsion to polymerize and cross-link the droplets, the polymer fine particles having a particle (emulsion) state and a dispersion state corresponding to those of the original emulsion can be obtained.

According to the above-mentioned method, an emulsification apparatus having an extremely simple structure in which only a plurality of net bodies such as gauzes are disposed in a flow passage of fluid is used. Accordingly, the polymer fine particles having a suitable particle diameter and a narrow particle diameter distribution for use as an anti-blocking agent can be continuously obtained in a large amount. Since the present apparatus has a simple structure, it can be easily disassembled and easy to maintain. (Size and particle size distribution of polymer fine particles)

The method described above can manufacture the polymer fine particles having a suitable particle diameter and a narrow particle diameter distribution for use as an anti-blocking agent for a polyolefin-based resin. The polymer fine particles preferably have a volume average particle diameter of 1 μm to 60 μm, and more preferably 5 μm to 20 μm as measured by the Coulter Counter method. When the average particle diameter thereof is less than the lower limit, an appropriate anti-blocking effect cannot be achieved. When the average particle diameter thereof exceeds the upper limit, this causes the die build-up generation during the manufacture of a master batch. In addition to this, the outer appearance and transparency of the product film can be lowered.

The CV value calculated from the formula (I) is an index of a particle size distribution of polymer fine particles, and the larger the CV value is, the wider the particle size distribution is. The CV value is preferably 35% or less, and more preferably 30% or less.

CV value=(Standard deviation of particle diameter distribution)/(Volume average particle diameter)×100 (1).

When the CV value exceeds the upper limit of the range, the polymer fine particles include those having a larger diameter, resulting in defective dispersion. In this case, die build-up may occur during the manufacture of the master batch with a high probability.

### (Amount of Polymer Fine Particle to be Blended)

The blended amount of polymer fine particles in the anti-blocking agent master batch is 1 to 40 parts by mass, and preferably 5 to 30 parts by mass with respect to 100 parts by mass of a polyolefin-based resin. When the blended amount is less than the lower limit of this range, an anti-blocking property cannot be imparted to the product film. When it exceeds the upper limit, it is difficult to disperse the polymer fine particles. This may also affect the physical properties of the resulting film.

### (Manufacture of Master Batch)

The method for manufacturing an anti-blocking agent master batch may preferably be a known method as long as the method can disperse the polyolefin-based resin and the polymer fine particles uniformly. For example, they are mixed with a ribbon blender, a Henschel Mixer, or the like, and the mixture is melted and kneaded by an extruder, and extruded into a strand shape through a die of the extruder. Then, the strand is cut in an appropriate length to obtain the product as pellets. In this case, as needed, a known antioxidant, antistatic agent, lubricant, and the like additives can appropriately be blended.

### (Polyolefin-Based Resin Film)

In the polyolefin-based resin film of the present invention, the above-defined polyolefin-based resin is blended with the above anti-blocking agent master batch so that the amount of the polymer fine particles contained in the film is 0.01 to 2 parts by mass, and preferably 0.1 to 0.5 parts by mass, with respect to 100 parts by mass of the polyolefin-based resin. When the contained amount is less than the lower limit of the range, an anti-blocking property cannot be imparted to the product film. When it exceeds the upper limit, it may affect the physical properties of the resulting film.

When the polyolefin-based resin film is manufactured, the anti-blocking agent master batch of the present invention is diluted with the polyolefin-based resin so as to adjust the concentration of the anti-blocking agent in the product film to a desired concentration. The method for compounding the polyolefin-based resin with the anti-blocking agent master batch is not specifically limited as long as the method and the apparatus can mix them uniformly. The method can include mixing them with a ribbon blender, a Henschel Mixer, and the like, melting and kneading the resulting mixture with an extruder, and pelletizing the mixture. In this case, as needed, a known antioxidant, antistatic agent, lubricant, and the like additives can appropriately be blended. The thus obtained composition is used to manufacture a film by a known film forming method.

Hereinafter, the present invention will be specifically described by way of Examples.

### (Manufacturing Example 1 of Polymer Fine Particles)

An emulsification apparatus was produced by inserting, into a cylindrical casing having an inner diameter of 15 mm and a length of approximately 330 mm, 30 units each composed of a spacer having a length of 10 mm and an inner diameter of 10 mm and a gauze including a main gauze of 325/2400 mesh.

Methyl methacrylate (MMA) in which a 1 mass % benzoyl peroxide (being an initiator) and 20 mass % ethylene glycol dimethacrylate (being a cross-linking agent) were dissolved and an aqueous solution of a dispersing agent (0.5 mass % PVA 217, product of KURARAY Co., Ltd.) were used as the raw materials for emulsification. The raw materials were introduced into the above emulsification apparatus at flow rates of 17 ml/min and 33 ml/min, respectively, using separate plunger pumps to obtain an O—W type emulsion. The obtained emulsion was heated and stirred under the nitrogen atmosphere at 90° C. for three hours to give solid MMA polymer fine particles. The resulting polymer fine particles were dispersed in water. The volume average particle diameter was 10 μm and the CV value was 26% as determined by the following method.

The volume average particle diameter: measured using a Coulter Counter (Multisizer II, product of Beckman Coulter Inc.). The number of particles measured was 100,000. CV value: calculated by the following equation (1).

CV value=(Standard deviation of particle diameter distribution)/(Volume average particle diameter)×100 (1).

The same method was used to measure the volume average particle diameter and the CV value in the following Examples and Comparative Examples.

### (Manufacturing Example 2 of Polymer Fine Particles)

The same procedure as in Manufacturing example 1 was repeated except that the main gauze was changed to have 200/1400 mesh and the flow rates of MMA and the dispersing agent aqueous solution were 17 ml/min and 68 ml/min, respectively, to manufacture polymer fine particles. The volume average particle diameter of the polymer fine particles was 14 μm, and the CV value was 30%.

### (Manufacturing Example 3 of Polymer Fine Particles)

The same procedure as in Manufacturing example 1 was repeated except that the main gauze was changed to have 400/3000 mesh, an aqueous solution of a dispersing agent was 2.0 mass % PVA 217, and the flow rates of MMA and the dispersing agent aqueous solution were 8 ml/min and 42 ml/min, respectively, to manufacture polymer fine particles. The volume average particle diameter of the polymer fine particles was 6 μm, and the CV value was 27%.

### (Manufacturing Example 4 of Polymer Fine Particles)

300 parts of methyl methacrylate (MMA) in which a 1 mass % benzoyl peroxide was dissolved and 600 parts of an aqueous solution of a dispersing agent (1 mass % PVA 205, product of KURARAY Co., Ltd.) were used as the raw materials for emulsification. They were emulsified and dispersed using a TK homomixer (product of Tokushu Kika Kogyo) until the volume average particle diameter of the dispersed phase was 20 μm. This emulsion was used to polymerize the MMA in the emulsion by the method of Manufacturing example 1 of the polymer fine particles, thereby obtaining MMA polymer particles. The volume average particle diameter was 9 μm and the CV value was 58%.

### (Manufacturing Examples A to D of Master Batch)

According to the following procedures, four examples A to D were manufactured as a 10 mass % anti-blocking agent master batch for LLDPE film, LLDPE being a polyolefin-based resin.

1. The following polymer fine particles were used as the anti-blocking agent:

(1) Manufacturing example A of master batch: the fine particles obtained in Manufacturing example 1 of polymer fine particles;

(2) Manufacturing example B of master batch: the fine particles obtained in Manufacturing example 3 of polymer fine particles;

(3) Manufacturing example C of master batch: the fine particles obtained in Manufacturing example 4 of polymer fine particles;

(4) Manufacturing example D of master batch: cross-linked acryl fine particles, product of Soken Chemical & Engineering Co., Ltd: trade name MR-10G, volume average particle diameter 10 μm, CV value=41.5%.

2. LLDPE (UF641), a product of Japan Polyethylene Corporation, was used as a diluent resin for master batch.
3. 90 parts by mass of the diluent resin pellet and 10 parts by mass of any of the polymer fine particles as described in the items (1) to (4) were dry-blended, and extrusion-molded by a small-sized twin screw extruder (HK25D, a product of Parker Corporation) under the conditions wherein the temperatures at the inlet, screw portion, mesh portion, and die outlet were 61° C., 200° C., 190° C. and 180° C., respectively, and a strand diameter 0 is 5 mm, thereby obtaining master batch pellets A to D.

When visually inspecting the die outlet portion, there was no die build-up generation in Master Batch Manufacturing Examples A and B. In Master Batch Manufacturing Examples C and D, after three minutes had passed since the strand was extruded, a white powdery material (die build-up) was confirmed to be adhered at the die outlet portion and increased in amount with time. The die build-up in Master Batch Manufacturing Example D was collected to be visually observed by an optical microscope, revealing that the component was the anti-blocking agent. The collected die build-up was re-dispersed in water, and the particle diameter was measured by a Coulter Counter and found to be a particle having a volume average particle diameter of 16 μm.

### (Application Example to a Polyolefin-Based Resin Film)

The following example shows the case where part of the master batch manufactured by the above-mentioned Master Batch Manufacturing Examples was used as an anti-blocking agent for producing an LLDPE film. In order to effectively utilize the anti-blocking agent, the anti-blocking agent was not added to all layers of the film, but a film is produced by the two-layer extrusion molding method in which the anti-blocking agent was added only to the outermost layer being a sealant layer, thereby evaluating the film blocking property.

### (Manufacturing Example of Two Types of Two-Layered Film)

The master batch manufactured in Master Batch Manufacturing Example A (referred to as MB-A) and the master batch manufactured in Master Batch Manufacturing Example D (referred to as MB-D) were added to HARMOLEX LLDPE (564A) (a product of Japan Polyethylene Corporation) in a raw material tank for a sealant layer of a two-layer film extruder in a blending ratio as shown in Table 1. The master batch was coextruded with HARMOLEX LLDPE (564A) stored in another raw material tank for a base layer by a T-die molding machine so as to form two layers, thereby obtaining samples 1 to 5 for film test as shown in Table 1. The apparatus and operation conditions that were used are as follows.

Apparatus Used

Two-layer film extruder: T-die extrusion molding machine (Soken): Die width 250 mm, rip width 0.1 mm

Extruder Base layer: screw size φ25, L/D=25
Sealant layer: screw size φ30, L/D=38

Operation Conditions

Pre-blending: in-bag dry blending (manual procedure)

Amounts extruded: base layer/sealant layer=4/1, film thickness 45 to 50 μm

Film take-off speed 3.5 m/min

Extruder: 210° C.

Take-off roll temperature: 65° C. (Note that the base layer side serves as a film contact surface.)

TABLE 1

| | | Film |
|---|---|---|
| | | Thickness μm |
| | Constitution of Materials for | Layer Ratio |
| Sample | Two-layered Film | (Base Layer/ |
| No. | Base Layer/Sealant Layer | Sealant Layer) |
| 1 | HARMOLEX LLDPE (564A)/ | 50 |
| | HARMOLEX LLDPE (564A) (MB-A 5%) | (4/1) |
| 2 | HARMOLEX LLDPE (564A)/ | 50 |
| | HARMOLEX LLDPE (564A) (MB-A 3%) | (4/1) |
| 3 | HARMOLEX LLDPE (564A)/ | 50 |
| | HARMOLEX LLDPE (564A) (MB-A 1.5%) | (4/1) |
| 4 | HARMOLEX LLDPE (564A)/ | 50 |
| | HARMOLEX LLDPE (564A) (MB-D 3%) | (4/1) |
| 5 | HARMOLEX LLDPE (564A)/ | 50 |
| | HARMOLEX LLDPE (564A) (MB-D 1.5%) | (4/1) |

### (Evaluation of Film Blocking Property)

The sample films obtained in the Film Manufacturing Examples as above were evaluated in accordance with the following method to obtain data.

The sealant layers of the sample film were brought into contact with each other for measurement. The test piece was cut in the MD direction.
Shape of test piece: width 20 mm, length 150 mm, two pieces were handled as a pair.

Overlapping area for blocking evaluation: 20 mm×50 mm (10 cm²)

Load and loading conditions: 5 kg/10 cm², at 60° C. for 5 hours

Conditioning after removal of load: the samples were left at 23° C. and 50% RH for 24 hours

Speed for peel test: 500 mm/min.

Test temperature and relative humidity: at 23° C. and 50% RH

Number of test: n=8

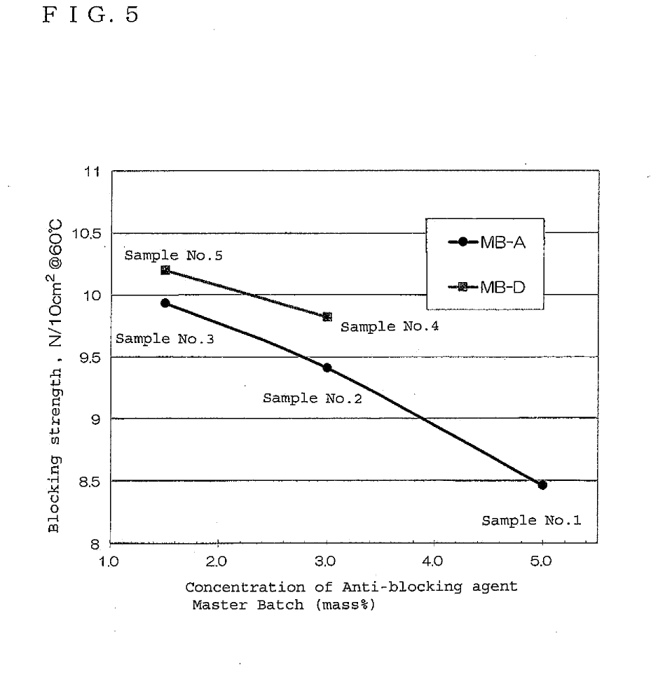

The obtained test results are shown in FIG. 5, illustrating the relationship between the added amount of polymer fine particles and film blocking strength.

These results reveal that the products of the present invention can demonstrate the same antiblocking performance as other products using the polymer fine particles from other companies even when the products of the present invention contained the particles with less added amounts (approximately 65%).

### INDUSTRIAL APPLICABILITY

When manufacturing the anti-blocking agent master batch of the present invention, the die build-up does not generate. Accordingly, when a film is formed, the master batch is diluted with a polyolefin-based resin to adjust an appropriate contained amount of the anti-blocking agent. By doing so, the film obtained has a superior anti-blocking property. Therefore, the film can be utilized as various packaging materials, industrial materials and the like for manufacturing high quality products.

1. An anti-blocking agent master batch obtained by compounding 100 parts by mass of a polyolefin-based resin with 1 to 40 parts by mass of polymer fine particles, the polymer fine particles obtained by: causing two or more fluids including a liquid medium, a monomer or monomers, and a polymerization initiator to continuously and successively pass through a plurality of net bodies which are disposed at given intervals in a cylindrical passage and each have a surface crossing a direction of the passage to obtain an emulsion including liquid droplets containing the monomer or monomers and the polymerization initiator, the liquid droplets being dispersed in the liquid medium; and heating this emulsion to polymerize the monomer or monomers.

2. The anti-blocking agent master batch according to claim 1, wherein the polymer fine particles have a volume average particle diameter of 1 μm to 60 μm as determined by a Coulter Counter method and a CV value of 35% or less as determined by the following equation (1):
CV value=(Standard deviation of particle diameter distribution)/(Volume average particle diameter)×100 (1).

3. The anti-blocking agent master batch according to claim 1, wherein the polymer fine particles are obtained by polymerizing an acrylic monomer or a styrenic monomer, or other polymerizable vinyl monomer or monomers.

4. The anti-blocking agent master batch according to claim 1, wherein the polyolefin-based resin is a polyethylene-based resin.

5. The anti-blocking agent master batch according to claim 1, wherein the polyolefin-based resin is a polypropylene-based resin.

6. The anti-blocking agent master batch according to claim 1, wherein: the net bodies each have a mesh number of 35 to 4000 in accordance with an ASTM standard; the number of the disposed net bodies are 5 to 100; and the adjacent net bodies are disposed at intervals of 5 to 200 mM.

7. A polyolefin-based resin film prepared by compounding and molding a polyolefin-based resin and the anti-blocking master agent batch according to claim 1.

8. A method for manufacturing an anti-blocking agent master batch, the method comprising compounding 100 parts by mass of a polyolefin-based resin with 1 to 40 parts by mass of polymer fine particles, the polymer fine particles obtained by: causing two or more fluids including a liquid medium, a monomer or monomers, and a polymerization initiator to continuously and successively pass through a plurality of net bodies which are disposed at given intervals in a cylindrical passage and each have a surface crossing a direction of the passage to obtain an emulsion including liquid droplets containing the monomer or monomers and the polymerization initiator, the liquid droplets being dispersed in the liquid medium; and heating this emulsion to polymerize the monomer or monomers.

9. The method for manufacturing an anti-blocking agent master batch according to claim 8, wherein the polymer fine particles have a volume average particle diameter of 1 μm to 60 μm as determined by a Coulter Counter method and a CV value of 35% or less as determined by the following equation (1):
CV value=(Standard deviation of particle diameter distribution)/(Volume average particle diameter)×100 (1).

10. The method for manufacturing an anti-blocking agent master batch according to claim 8, wherein the polymer fine particles are obtained by polymerizing an acrylic monomer or a styrenic monomer, or other polymerizable vinyl monomer or monomers.

11. The method for manufacturing an anti-blocking agent master batch according to claim 8, wherein the polyolefin-based resin is a polyethylene-based resin.

12. The method for manufacturing an anti-blocking agent master batch according to claim 8, wherein the polyolefin-based resin is a polypropylene-based resin.

13. The method for manufacturing an anti-blocking agent master batch according to claim 8, wherein: the net bodies each have a mesh number of 35 to 4000 in accordance with an ASTM standard; the number of the disposed net bodies are 5 to 100; and the adjacent net bodies are disposed at intervals of 5 to 200 mm.

14. A polyolefin-based resin film prepared by compounding and molding a polyolefin-based resin and the anti-blocking agent master batch obtained by the method for manufacturing an anti-blocking agent master batch according to claim 8.

15. The anti-blocking agent master batch according to claim 2, wherein the polymer fine particles are obtained by polymerizing an acrylic monomer or a styrenic monomer, or other polymerizable vinyl monomer or monomers.

16. The anti-blocking agent master batch according to claim 2, wherein the polyolefin-based resin is a polyethylene-based resin.

17. The anti-blocking agent master batch according to claim 2, wherein the polyolefin-based resin is a polypropylene-based resin.

18. The anti-blocking agent master batch according to claim 2, wherein: the net bodies each have a mesh number of 35 to 4000 in accordance with an ASTM standard; the number of the disposed net bodies are 5 to 100; and the adjacent net bodies are disposed at intervals of 5 to 200 mm.

19. The anti-blocking agent master batch according to claim 3, wherein: the net bodies each have a mesh number of 35 to 4000 in accordance with an ASTM standard; the number of the disposed net bodies are 5 to 100; and the adjacent net bodies are disposed at intervals of 5 to 200 mm.

20. The anti-blocking agent master batch according to claim 4, wherein: the net bodies each have a mesh number of 35 to 4000 in accordance with an ASTM standard; the number of the disposed net bodies are 5 to 100; and the adjacent net bodies are disposed at intervals of 5 to 200 mm.

21. The anti-blocking agent master batch according to claim 5, wherein: the net bodies each have a mesh number of 35 to 4000 in accordance with an ASTM standard; the number of the disposed net bodies are 5 to 100; and the adjacent net bodies are disposed at intervals of 5 to 200 mm.

22. The method for manufacturing an anti-blocking agent master batch according to claim 9, wherein the polymer fine particles are obtained by polymerizing an acrylic monomer or a styrenic monomer, or other polymerizable vinyl monomer or monomers.

23. The method for manufacturing an anti-blocking agent master batch according to claim 9, wherein the polyolefin-based resin is a polyethylene-based resin.

24. The method for manufacturing an anti-blocking agent master batch according to claim 9, wherein the polyolefin-based resin is a polypropylene-based resin.
